(19) United States
(12) Patent Application Publication
(10) Pub. No.: US 2008/0077273 A1
(43) Pub. Date: Mar. 27, 2008

(54) Zero footprint mobile loadport

(76) Inventors: Jeffrey P Gifford, Fishkill, NY (US); David J. Pinckney, Newtown, CT (US); Benjamin R. Wheeler, Wappingers Falls, NY (US); Uldis A. Ziemins, Poughkeepsie, NY (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/535,157

(22) Filed: Sep. 26, 2006

(51) Int. Cl. G06F 7/00

(52) U.S. Cl. 700/228

(57) ABSTRACT

A method of transporting workpieces to tools in an automated transportation system dispatches an automated transport vehicle containing workpieces from a first location such as a first loadport to a tool when the automated transport vehicle is available for dispatch and loaded with the workpieces, irrespective of whether the tool is available to receive the workpieces. Next, the method directs the automated transport vehicle to travel from the first loadport, along an interbay loop to an intrabay loop. The intrabay loop comprises a transport route around the tool and the interbay loop comprises a transport route that connects the loadport to a plurality of intrabay loops. The method directs the automated transport vehicle to travel along the interbay loop and stop at a tool loadport of the tool only if the tool is available to work on the workpieces. If the tool is not available to work on the workpieces when the automated transport vehicle arrives at the intrabay loop, the method directs the automated transport vehicle to continuously travel around the intrabay transport loop until the tool is available. Thus, the automated transport vehicle comprises a portable zero footprint storage location while it is continuously circling the intrabay loop waiting for the tool to become available to accept the workpieces it holds.

### BACKGROUND AND SUMMARY

### Field of the Invention

The embodiments of the invention generally relate to automated transport systems for transporting workpieces to tools.

Automation is becoming more prevalent in semi-conductor manufacturing plants and high value-add product manufacturing plants such as SOI (silicon on insulator) wafers and Liquid Crystal Displays (LCD). Automation is defined as using powered vehicles on a track to transport product from location A to location B. With that comes the necessity to complete product deliveries expeditiously to minimize idle time on manufacturing tools. Many plants have segregated automation systems which entail an Interbay (non-local) main artery (or track) and interface with an Intrabay (local) segregated loops (or track). Staging “work in process” (WIP) as close to possible to the next process tool is imperative to keeping transport times manageable, especially with comparatively short process time tools. Comparatively short process time tools are underutilized when the Automated Material Handling System (AMHS) cannot feed the tools fast enough due to system architecture. The present invention allows for product to be pre-positioned into a particular intrabay loop, thereby requiring only a local transaction to complete tool delivery, reducing the average duration of a transport significantly.

Utilization of the transport vehicles as a dedicated loadport for a particular tool or groups of tools is one feature of this disclosure. A loadport is a buffer location attached to a tool for storage of incoming and outgoing wip from a tool. There are limits on the quantities of loadports that a particular tool can have due to space, cost, etc. Because of these limitations the number of loadports that a tool has may be insufficient to keep enough work in process (wip) on a tool. In other words the Automated Material Handling System sometimes cannot supply work fast enough to the tools. This happens consistently when the process time of the tool multiplied by the number of loadports is shorter than the total transport time. The transportion time is also a hindrance to tool thruput during periods when the tool is not consistently loaded due to wip availability.

Work in process can be stored in stockers until a loadport of the tool where the next operation is to be completed becomes available. These storage stockers are not always located close in proximity to the next processing tool location, thereby requiring a lengthy Automated Material Handling System transport. This invention implementation selectively dedicates an Automated Material Handling System vehicle as a loadport for a particular tool or set of tools.

Briefly, with the invention, when an automated vehicle becomes available for dispatch to the next operation toolset's loadport, a Material Execution System (MES) will solicit input from tool communication software to see if there is an available loadport on the next processing tool. If yes, the MES signals a Manufacturing Control System(MCS) to generate a move transaction for that automated vehicle to be delivered to the vacant loadport. If no loadport is available, the MES signals the MCS to reclassify an Automated Material Handling vehicle from a transport vehicle to an end storage location. The MES signals the MCS to generate a transportation command for the automated vehicle to be transported to the newly created Zero Footprint Mobile loadport location. When the MES receives confirmation that there is a vacant loadport available, the MES signals the MCS to generate a transportation command from the Zero Footprint Mobile Loadport to the available loadport. MCS then reclassifies the Zero Footprint Mobile Loadport back to a transport vehicle. Typically, the first order of sequence is that a job to be processed arrives in queue. If a tool loadport is available, then the MES signals the MCS for a “move transaction to tool loadport” command. If no loadport is available, then the MES signals the MCS to generate a command for the automated vehicle to be transported to the newly created Zero Footprint Mobile loadport location. When the MES receives confirmation that there is a vacant loadport available, the MES signals the MCS to generate a transportation command from the Zero Footprint Mobile Loadport to the available loadport. The MCS then reclassifies the Zero Footprint Mobile Loadport back to a transport vehicle.

In view of the foregoing, an embodiment of the invention provides a method of transporting workpieces to tools in an automated transportation system. The method dispatches an automated transport vehicle containing workpieces from a first location such as a first loadport to a tool when the automated transport vehicle is available for dispatch and loaded with the workpieces, irrespective of whether the tool is available to receive the workpieces. Next, the method directs the automated transport vehicle to travel from the first loadport, along an interbay loop to an intrabay loop. The intrabay loop comprises a transport route around the tool and the interbay loop comprises a transport route that connects the loadport to a plurality of intrabay loops. The method directs the automated transport vehicle to travel along the interbay loop and stop at a tool loadport of the tool only if the tool is available to work on the workpieces. If the tool is not available to work on the workpieces when the automated transport vehicle arrives at the intrabay loop, the method directs the automated transport vehicle to continuously travel around the intrabay transport loop until the tool is available. The intrabay loop comprises a circular transport route that can be continuously traversed, such that the automated transport vehicle can continuously move along the intrabay loop without having to exit the interbay loop and without having to stop. Thus, the automated transport vehicle comprises a portable zero footprint storage location while it is continuously circling the intrabay loop waiting for the tool to become available to accept the workpieces it holds.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a preferred method of an embodiment of the invention; and

FIG. 2 illustrates a schematic diagram of an automated transport system.

### DETAILED DESCRIPTION

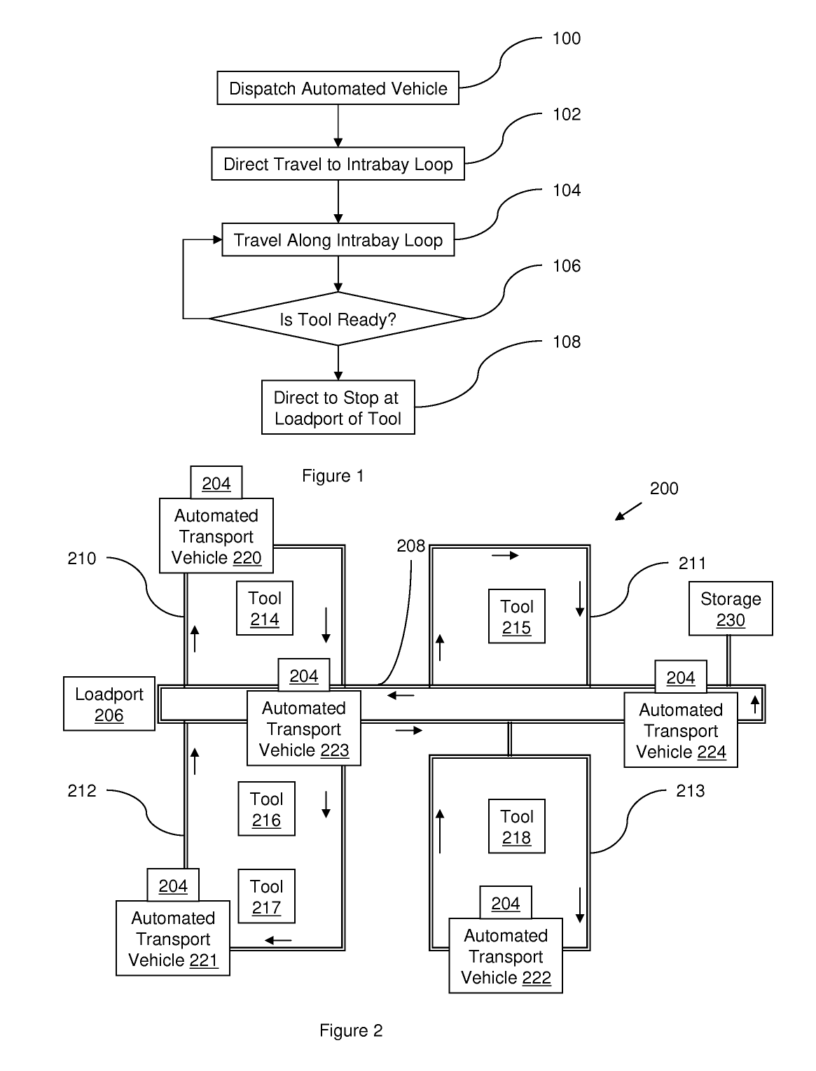

In view of the foregoing, an embodiment of the invention provides a method of transporting workpieces to tools in an automated transportation system. More specifically as shown in flowchart form in FIG. 1, the method first dispatches an automated transport vehicle containing workpieces in item 100. The automated transport vehicle is sent from a first location, such as a first loadport, to a tool when the automated transport vehicle is available for dispatch and loaded with the workpieces. The dispatching in item 100 is performed irrespective of whether the tool is available to receive the workpieces.

Next, as shown in item 102, the method directs the automated transport vehicle to travel from the first loadport, along an interbay loop, to an intrabay loop. The intrabay loop comprises a transport route around the tool and the interbay loop comprises a transport route that connects the loadport to a plurality of intrabay loops. The then method directs the automated transport vehicle to travel along the intrabay loop in item 104.

As show by the decision box in item 106, the automated transport vehicle is directed to stop at a tool loadport of the tool (in item 108) only if the tool is available to work on the workpieces. If the tool is not available to work on the workpieces when the automated transport vehicle arrives at the intrabay loop, as shown by the arrow from item 106 to item 104, the method directs the automated transport vehicle to continuously travel around the intrabay transport loop until the tool is available.

Referring now to FIG. 2, one example of an automated transportation system 200 is illustrated in schematic form. Various automated transport vehicles 220-224 are shown containing workpieces 204. The workpieces 204 can all be the same, or different automated transport vehicles can hold different workpieces 204 (or workpieces 204 that are at different manufacturing stages).

The “first location” mentioned above is shown as a first loadport 206, but can be any loadport at any of the tools 214-218. Many intrabay loops 210-213 are shown connected to the first loadport 206 by an interbay loop 208. The intrabay loops 210-213 comprises transport routes around one or more tools 214-218. The interbay loop 208 comprise one or more transport routes that connects the loadport 206 to the different intrabay loops 210-213 and can overlap with some of the intrabay loops 210-213.

The method directs one of the automated transport vehicles (e.g., vehicle 222) to travel along the interbay loop 208 and stop at a tool loadport of one of the tools (e.g., tool 218) only if tool 218 is available to work on the workpieces 204. If tool 218 is not available to work on the workpieces 204 when automated transport vehicle 222 arrives at intrabay loop 213, the method directs automated transport vehicle 222 to continuously travel around intrabay transport loop 213 until tool 218 is available.

Each of the intrabay loops 210-213 comprise a circular transport route, as shown by the travel direction arrows, that can be continuously traversed. Thus, the automated transport vehicles 220-224 can continuously move along the intrabay loops 210-213 without having to exit the interbay loops 210-213 and without having to stop. Thus, the automated transport vehicles 220-224 comprise portable zero footprint storage locations while they are continuously circling the intrabay loops 210-213 waiting for the tools 214-218 to become available to accept the workpieces 204 they hold.

Thus, as shown above, the dispatching (in item 100) of the automated transport vehicles 220-224 is performed irrespective of whether the tool is available to receive the workpieces. Thus, workpieces can be sent to the next tool on which they need to be processed, without having to wait in a dedicated waiting location or automated transport vehicle storage facility 230 for the tool to become available, and such storage location(s) 230 can be minimized or eliminated. Further, because the intrabay loops 210-213 are closer to their respective tools than are the storage locations 230, there is less delay in moving the automated transport vehicles 220-224 to the tools 214-218 when the tools become available. In addition, controls can be put in place to ensure that limits are placed on the number of automated transport vehicles that are allowed in any given interbay loop to avoid inefficiencies associated with overcrowding.

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention. The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

1. A method of transporting workpieces to tools in an automated transportation system, said method comprising:
dispatching an automated transport vehicle containing workpieces from a first location to a tool when said automated transport vehicle is available for dispatch, irrespective of whether said tool is available to receive said workpieces;
directing said automated transport vehicle to travel from said first location, along an first transportation loop to a second transportation loop, wherein said second transportation loop comprises a transport route around said tool and said first transportation loop comprises a transport route that connects said location to a plurality of transportation loops; and
directing said automated transport vehicle to continuously travel along said first transportation loop and stop at a tool location of said tool only if said tool is available to work on said workpieces.

2. The method according to claim 1, all the limitations of which are incorporated herein by reference, wherein if said tool is not available to work on said workpieces when said automated transport vehicle arrives at said second transportation loop, said method further comprises directing said automated transport vehicle to continuously travel around said intrabay transport loop until said tool is available.

3. The method according to claim 1, all the limitations of which are incorporated herein by reference, wherein said second transportation loop comprises a circular transport route that can be continuously traversed, such that said automated transport vehicle can continuously move along said second transportation loop without having to exit said second transportation loop and without having to stop.

4. A method of transporting workpieces to tools in an automated transportation system, said method comprising:
dispatching an automated transport vehicle containing workpieces from a first loadport to a tool when said automated transport vehicle is available for dispatch and loaded with said workpieces, irrespective of whether said tool is available to receive said workpieces;
directing said automated transport vehicle to travel from said first loadport, along an interbay loop to an intrabay loop, wherein said intrabay loop comprises a transport route around said tool and said interbay loop comprises a transport route that connects said loadport to a plurality of intrabay loops; and
directing said automated transport vehicle to continuously travel along said interbay loop and stop at a tool loadport of said tool only if said tool is available to work on said workpieces.

5. The method according to claim 4, all the limitations of which are incorporated herein by reference, wherein if said tool is not available to work on said workpieces when said automated transport vehicle arrives at said intrabay loop, said method further comprises directing said automated transport vehicle to continuously travel around said intrabay transport loop until said tool is available.

6. The method according to claim 4, all the limitations of which are incorporated herein by reference, wherein said intrabay loop comprises a circular transport route that can be continuously traversed, such that said automated transport vehicle can continuously move along said intrabay loop without having to exit said interbay loop and without having to stop.
